(19) United States
(12) Patent Application Publication
(10) Pub. No.: US 2023/0396014 A1
(43) Pub. Date: Dec. 7, 2023

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Tetsuya MIYAMURA, Mie (JP)

(21) Appl. No.: 18/032,177

(22) PCT Filed: Oct. 12, 2021
(86) PCT No.: PCT/JP2021/037755

§ 371 Date: Apr. 16, 2023

(30) Foreign Application Priority Data
Nov. 2, 2020 (JP) 2020-183419

(51) Int. Cl. H01R 13/518; H01R 13/514

(52) U.S. Cl. CPC H01R 13/518; H01R 12/716; H01R 13/514

(57) ABSTRACT

Provided is a connector capable of suppressing a fitting operation force. A connector (1) composes: a plurality of housings (10A, 10B, 10C), a mating-side housing (12) to which the housings (10A, 10B, 10C) are fitted; and a frame (11) that, in a process of approaching the mating-side housing (12), presses the housings (10A, 10B, 10C) at different timings in the direction approaching the mating-side housing (12).

### TECHNICAL FIELD

The present disclosure relates to a connector.

### BACKGROUND

A conventional lever-type connector is disclosed in Patent Document 1. In this connector, a male housing and a female housing can be easily connected by converting a force for rotating a lever into a force for connecting the male housing and the female housing. A conventional slide-type connector is disclosed in Patent Document 2. In this connector, a second connector can be connected to a first connector by locking a boss provided on the second connector into a cam groove formed in a slider and pushing the slider into a housing.

### PRIOR ART DOCUMENT

### Patent Document

Patent Document 1: JP 2020-126714 A

Patent Document 2: WO 2018/061981 A1

### SUMMARY OF THE INVENTION

### Problem to be Solved

In the case of adopting a lever as in Patent Document 1, the outer shape of a connector becomes larger by providing the lever. Further, it is necessary to secure a rotation path of the lever. Thus, in mounting a component around the connector, the component is mounted while avoiding the rotation path of the lever, which possibly hinders an improvement in mounting efficiency. In contrast, if a slider is provided as in Patent Document, the enlargement of a connector and a reduction in mounting efficiency can be avoided. However, in the connector using the slider, an effect of reducing a connection operation force required for connector connection is thought to be reduced if the number of terminals is increased.

The present disclosure was completed on the basis of the above situation and aims to provide a connector capable of suppressing a connection operation force.

### Means to Solve the Problem

The present disclosure is directed to a connector with a plurality of housings, a mating housing to be connected to the plurality of housings, and a pressing member for pressing the plurality of housings in a direction approaching the mating housing respectively at different timings in the process of approaching the mating housing.

### EFFECT OF THE INVENTION

According to the present disclosure, it is possible to suppress a connection operation force.

### BRIEF DESCRIPTION OF THE DRAWINGS

FIG. 1 is an exploded perspective view of a connector of one embodiment.

FIG. 2 is a plan view of a frame of the embodiment.

FIG. 3 is a plan view of a mating housing, a board and male terminal fittings of the embodiment.

FIG. 4 is a plan view showing a state where the frame assembled with a plurality of housings is opposed to the mating housing.

FIG. 5 is a plan view showing a state where the frame assembled with the plurality of housings is inserted in the mating housing.

FIG. 6 is a plan view showing a state where the frame assembled with the plurality of housings is moved rightward while being inserted into the mating housing.

FIG. 7 is a plan view showing a state where a connecting operation of the left housing is finished by inserting the frame assembled with the plurality of housings into the mating housing.

FIG. 8 is a plan view showing a state where the frame is moved rightward after the connecting operation of the left housing is finished.

FIG. 9 is a plan view showing a state where a connecting operation of the central housing is finished by inserting the frame assembled with the plurality of housings into the mating housing.

FIG. 10 is a plan view showing a state where the frame is moved rightward after the connecting operation of the central housing is finished.

FIG. 11 is a plan view showing a state where a connecting operation of the right housing is finished by inserting the frame assembled with the plurality of housings into the mating housing.

FIG. 12 is a plan view showing a state where the left housing is separated by moving the frame assembled with the plurality of housings rearward.

FIG. 13 is a plan view showing a state where the frame is moved leftward after the left housing is separated.

FIG. 14 is a plan view showing a state where the central housing is separated by moving the frame assembled with the plurality of housings rearward.

FIG. 15 is a plan view showing a state where the frame is moved leftward after the central housing is separated.

FIG. 16 is a plan view showing a state where the right housing is separated by moving the frame assembled with the plurality of housings rearward.

FIG. 17 is a plan view showing a state where the respective housings are moved rearward.

FIG. 18 is a plan view showing a state where the frame is moved leftward after the respective housings are moved rearward and the frame and the plurality of housings are separable from the mating housing.

### DETAILED DESCRIPTION TO EXECUTE THE INVENTION

### Description of Embodiments of Present Disclosure

First, embodiments of the present disclosure are listed and described.
(1) The connector of the present disclosure is provided with a plurality of housings, a mating housing to be connected to the plurality of housings, and a pressing member for pressing the plurality of housings in a direction approaching the mating housing respectively at different timings in the process of approaching the mating housing. According to this configuration, since the pressing member presses the respective housings at different timings, a connection operation force required to connect the housings and the mating housing is dispersed. Therefore, according to the present disclosure, the connection operation force can be reduced as compared to the case where all the housings are simultaneously pressed.
(2) Preferably, each of the plurality of housings of the connector of the present disclosure includes a first cam pin, the pressing member includes a first guide groove formed with a plurality of pressing surfaces for pressing a plurality of the first cam pins respectively at the different timings and second cam pins, the mating housing includes a receptacle for accommodating the plurality of housings, and the receptacle includes a plurality of second guide grooves for individually guiding a plurality of the second cam pins. According to this configuration, since a movement path of the pressing member with respect to the mating housing is stabilized, the pressing member can press the plurality of housings at proper timings.
(3) Preferably, the plurality of first cam pins of the connector of the present disclosure include different diameter portions having mutually different outer diameters, the pressing member includes a guiding groove for guiding the first cam pins into the first guide groove, and the guiding groove includes a restricting portion for restricting passage of some different diameter portions, out of the plurality of different diameter portions. According to this configuration, the restricting portion restricts the passage of some different diameter portions in the process that the first cam pins pass through the guiding groove as the housings are mounted into the pressing member. In this way, the plurality of housings can be assembled with the pressing member in a proper order.
(4) Preferably, the first cam pin of the connector of the present disclosure includes an escape preventing portion for preventing the first cam pin from coming out from the first guide groove. According to this configuration, the housings can be prevented from coming out from the pressing member.
(5) Preferably, the pressing member of the connector of the present disclosure includes a separation restricting portion for restricting separation of the first cam pins from the first guide groove by locking the first cam pin. According to this configuration, the housings and the pressing member in a temporarily assembled state can be easily handled by restricting the separation of the housings from the pressing member.
(6) Preferably, the separation restricting portion of the connector of the present disclosure is separable from the first cam pin by being resiliently deformed, and the plurality of second guide grooves have inclined surfaces for moving the second cam pins such that the separation restricting portion is separated from the first cam pin while being resiliently deformed in the process of pressing the first cam pin locked by the separation restricting portion by an initial pressing surface formed in the first guide groove. According to this configuration, if the second cam pins move along the inclined surfaces, the housing having the first cam pin locked by the separation restricting portion approaches the mating housing and the separation restricting portion is separated from the first cam pin. Workability is excellent as compared to the case where an operation of separating the first cam pin from the separation restricting portion is performed separately from a connecting operation of the housing and the mating housing.
(7) Preferably, the plurality of housings of the connector of the present disclosure are coupled relatively movably in a direction parallel to a connecting direction of the plurality of housings to the mating housing while being arranged side by side in a direction orthogonal to the connecting direction. According to this configuration, since the plurality of housings do not come apart from each other, the plurality of housings can be assembled with the pressing member by one action.

### DETAILS OF EMBODIMENT OF PRESENT DISCLOSURE

### Embodiment

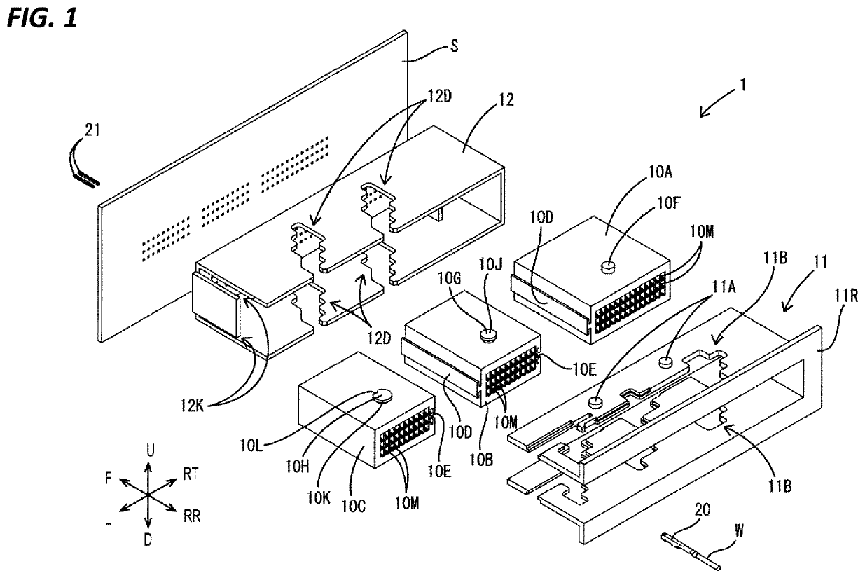

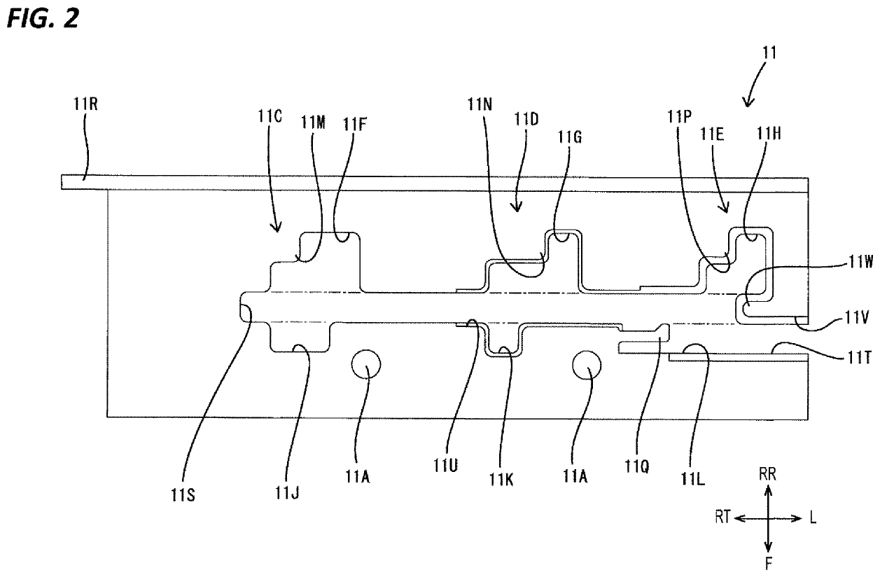

One specific embodiment of the present disclosure is described below with reference to FIGS. 1 to 18. In the following description, left and right sides shown in FIG. 2 are directly defined as left and right sides concerning a lateral direction. Frontal and back sides in FIG. 2 are defined as upper and lower sides concerning a vertical direction. Upper and lower sides in FIG. 2 are defined as rear and front sides concerning a front-rear direction.

A connector 1 of this embodiment is, as shown in FIG. 1, provided with a plurality of housings 10A, 10B and 10C, one frame 11 serving as a pressing member for holding the plurality of housings 10A, 10B and 10C, and one mating housing 12 to be connected to the plurality of housings 10A, 10B and 10C.

### Configuration of Housings

Each housing 10A, 10B, 10C is made of synthetic resin. Each housing 10A, 10C is substantially in the form of a block. Each housing 10A, 10B, 10C is formed with a plurality of terminal accommodation chambers 10M for accommodating female terminal fittings 20 fixed to wires W. The terminal accommodation chambers formed in the respective housings 10A, 10B and 10C are in the same form. The terminal accommodation chambers 10M are arranged in the vertical direction and lateral direction. The rear ends of the terminal accommodation chambers 10M are open in the rear end surface of each housing 10A, 10B, 10C.

The respective housings 10A, 10B and 10C have the same dimensions in the front-rear direction and vertical direction. The number of the terminal accommodation chambers 10M formed in the housing 10A is more than those of the terminal accommodation chambers 10M formed in the housings 10B, 10C. Thus, a dimension of the housing 10A in the lateral direction is larger than those of the housings 10B, 10C.

An engaging portion 10D projecting leftward is provided on the left surface of each of the housings 10A, 10B. The engaging portion 10D extends from a front end to a rear end on the left surface of each of the housings 10A, 10B. A tip part of the engaging portion 10D is in the form of a rib expanding upward and downward. An engaged portion 10E recessed leftward is formed in the right surface of each of the housings 10B, 10C. The engaged portion 10E is formed from a front end to a rear end of the right surface of each of the housings 10B, 10C. A back part of the engaged portion 10E is formed to expand upward and downward. The engaging portion 10E of the housing 10A can be inserted into the engaged portion 10E of the housing 10B from front or behind. The engaging portion 10E of the housing 10B can be inserted into the engaged portion 10E of the housing 10C from front or behind. By inserting the engaging portions 10D into the engaged portions 10E, the respective housings 10A, 10B and 10C can be coupled side by side in the lateral direction, which is one direction.

Each housing 10A, 10B, 10C includes one first cam pin 10F, 10G, 10H on each of upper and lower surfaces. The first cam pins 10F, 10G and 10H provided on the lower surfaces are not shown. Each first cam pin 10F, 10G, 10H has a cylindrical shape. An external dimension of each first cam pin 10F, 10G, 10H is equal to a groove width of a guiding groove 11S. The first cam pin 10F is provided in a rear part of each of the upper and lower surfaces of the housing 10A with a center axis oriented in the vertical direction. The first cam pin 10G is provided in a rear part of each of the upper and lower surfaces of the housing 10B with a center axis oriented in the vertical direction. A different diameter portion 10J having an outer diameter larger than a base end part is provided on a tip part of the first cam pin 10G. The first cam pin 10H is provided in a rear part of each of the upper and lower surfaces of the housing 10C with a center axis oriented in the vertical direction. A different diameter portion 10K having an outer diameter larger than a base end part is provided on a tip part of the first cam pin 10H. The outer diameter of the different diameter portion 10K is larger than that of the different diameter portion 10J. That is, the different diameter portions 10J, 10K have mutually different outer diameters. The different diameter portion 10K is formed with a cut portion 10L by cutting a part of the different diameter portion 10K.

### Configuration of Frame

The frame 11 is formed into a U shape by bending a strip-like wall part and extends long in the lateral direction. The right end of the frame 11 in a longitudinal direction is closed, but the front end, rear end and left end thereof are open. The frame 11 is made of synthetic resin. A finger placing portion 11R bent outward is provided on the rear end of the frame 11. The frame 11 includes a plurality of second cam pins 11A and a pair of first guide grooves 11B. Each second cam pin 11A has a cylindrical shape. Two second cam pins 11A are provided on each of an upper wall outer surface and a lower wall outer surface of the frame 11 with center axes oriented in the vertical direction. On the upper and lower walls of the frame 11, the two second cam pins 11A are arranged in the lateral direction in a front end part of the frame 11. The two second cam pins 11A provided on the lower wall of the frame 11 are not shown.

One first guide groove 11B is formed in each of the upper and lower walls of the frame 11. In a top view of the frame 11, the respective first guide grooves 11B have the same outer shape. Each first guide groove 11B is formed from the left end to a right end part of the frame 11. As shown in FIG. 2, each first guide groove 11B includes the guiding groove 11S, an introducing groove 11T, a right first guide groove 11C, a central first guide groove 11D and a left first guide groove 11E. The guiding groove 11S has a predetermined width and extends long in the lateral direction. The introducing groove 11T is formed adjacent to a front side of a left end part of the guiding groove 11S and open in the left end of the frame 11. The right first guide groove 11C is located at a right end part of the guiding groove 115. The central first guide groove 11D is located in a laterally central part of the guiding groove 11S. The left first guide groove 11E is located at the left end part of the guiding groove 115. The guiding groove 11S is for guiding the first cam pins 10F, 10G and 10H respectively to the right first guide groove 11C, the central first guide groove 11D and the left first guide groove 11E.

Each of the right, central and left first guide grooves 11C, 11D and 11E is formed with a first recess 11F, 11G, 11H recessed rearward and a second recess 11J, 11K, 11L recessed forward. A protrusion 11M, 11N, 11P projecting leftward and forward is provided in a rear part of the right end of each of the first recesses 11F, 11G and 11H. A second protrusion 11W projecting rightward is provided in a front part of a left side of the first recess 11H. The second protrusion 11W is adjacent to the left end of the guiding groove 11S. The second recess 11L is equivalent to the right end part of the guiding groove 11S.

Step portions 11U recessed to expand groove widths of the central first guide groove 11D and the laterally central part of the guiding groove 11S are formed in the outer surface of the frame 11. Step portions 11V recessed to expand groove widths of the left first guide groove 11E, the left end part of the guiding groove 11S and the introducing groove 11T are formed in the left first guide groove 11E, the left end part of the guiding groove 11S and the introducing groove 11T. A width of the step portions 11U is smaller than that of the step portions 11V.

The width of the step portions 11U is equal to a radial projection dimension of the different diameter portion 10J from the outer periphery of the first cam pin 10G and smaller than a radial projection dimension of the different diameter portion 10K from the outer periphery of the first cam pin 10H of the housing 10C. A dimension from the front end of the front step portion 11U to the rear end of the rear step portion 11U in the guiding groove 11S is equal to the diameter of the different diameter portion 10J and smaller than the diameter of the different diameter portion 10K.

The width of the step portions 11V is larger than the radial projection dimension of the different diameter portion 10J from the outer periphery of the first cam pin 10G and equal to the radial projection dimension of the different diameter portion 10K from the outer periphery of the first cam pin 10H. A dimension from the front end of the front step portion 11V to the rear end of the rear step portion 11V in the introducing groove 11T is equal to the diameter of the different diameter portion 10K and larger than the diameter of the different diameter portion 10J. By this configuration, the right end of the guiding groove 11S not formed with the step portions 11U, 11V can allow the entrance of the first cam pin 10F and restrict the entrance of the first cam pins 10G, 10H.

The step portions 11U allow the entrance of the first cam pins 10F, 10G into the right first guide groove 11C and the central first guide groove 11D and restrict the entrance of the first cam pin 10H into the right first guide groove 11C and the central first guide groove 11D. That is, the step portions 11U of the guiding groove 11S function as a restricting portion for restricting the passage of the different diameter portions 10K, out of the different diameter portions 10J, 10K. That is, the guiding groove 11S includes the restricting portion (step portions 11U).

The frame 11 includes separation restricting portions 11Q. The separation restricting portion 11Q constitutes a part of the left side of the guiding groove 11S. The separation restricting portion 11Q is in the form of a cantilever extending leftward, and a tip part (left end part) projects rearward. The tip of the separation restricting portion 11Q is adjacent to the right side of the second recess 11L. The separation restricting portion 11Q is resiliently deformable in the front-rear direction.

### Configuration of Mating Housing

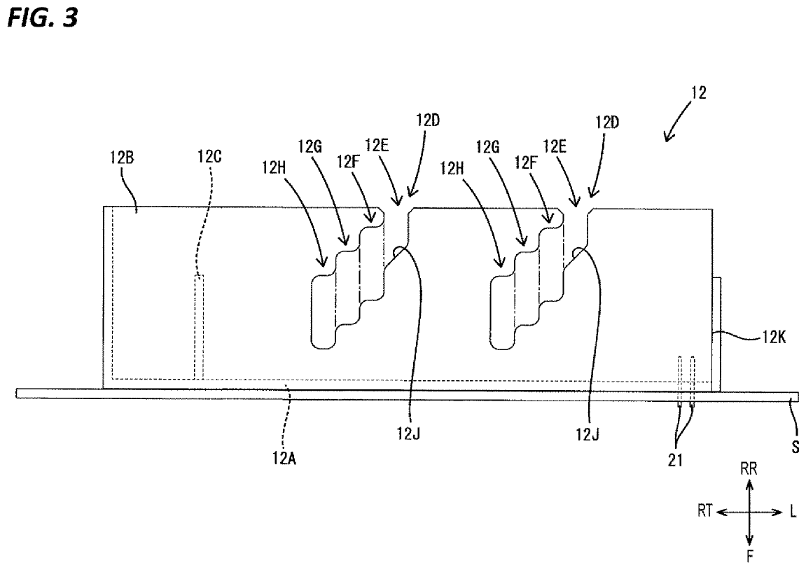

The mating housing 12 is mounted on a circuit board S as shown in FIG. 3. The mating housing 12 is made of synthetic resin. The mating housing 12 includes a base wall 12A arranged along the circuit board S and a receptacle 12B in the form of a tube continuous with the outer peripheral edge of the base wall 12A and extending rearward. The receptacle 12B accommodates the frame 11 and the plurality of housings 10A, 10B and 10C. The left, upper and lower walls of the receptacle 12B are not connected, and slits 12K are formed between the left and upper walls and between the left and lower walls (see FIG. 1).

In the mating housing 12, a plurality of male terminal fittings 21 in the form of tabs to be electrically connected to the circuit board S and rising perpendicularly from the circuit board S are mounted through the base wall 12A and tip parts thereof are arranged in the receptacle 12B. A restricting piece 12C extending rearward from the base wall 12A with a plate thickness direction oriented in the lateral direction is provided in a right end part inside the receptacle 12B. The upper and lower end edges of the restricting piece 12C are not connected to the upper and lower walls of the receptacle 12B and are separated therefrom by a predetermined dimension.

Second guide grooves 12D are formed in each of the upper and lower walls of the receptacle 12B. The respective second guide grooves 12D have the same plan view shape. The respective second guide grooves 12D have a function of individually guiding the plurality of second cam pins 11A. The respective second guide grooves 12D are formed by being cut forward from the rear ends of the upper and lower walls of the mating housing 12. The rear end of each second guide groove 12D is chamfered to expand in the lateral direction toward the rear.

Each second guide groove 12D includes an entrance region 12E, a left region 12F, a middle region 12G and a right region 12H. The entrance region 12E is cut forward from the rear end of the upper or lower wall. An inclined surface 12J inclined from a left-rear side to a right-front side is formed in a back part (front part) of the entrance region 12E. The left region 12F is a region to the right of and adjacent to the entrance region 12E, and the rear and front ends thereof are located forward of those of the entrance region 12E. The middle region 12G is a region to the right of and adjacent to the left region 12F, and the rear and front ends thereof are located forward of those of the left region 12F. The right region 12H is a region to the right of and adjacent to the middle region 12G, and the rear and front ends thereof are located forward of those of the middle region 12G.

### Connecting Process of Connector

Next, a connecting process of the connector 1 is described.

First, the plurality of housings 10A, 10B and 10C are coupled in this order. Specifically, the orientations of the housings 10A, 10B in the front-rear direction are aligned. Then, the engaging portion 10D of the housing 10A is inserted into the engaged portion 10E of the housing 10B. Subsequently, the orientation of the housing 10C in the front-rear direction is aligned with those of the housings 10A, 10B in the front-rear direction. Then, the engaging portion 10D of the housing 10B is inserted into the engaged portion 10E of the housing 10C. The housings 10A, 10B and 10C can be coupled side by side in one direction in this way. In this state, the respective housings 10B and 10C are relatively movable in a direction orthogonal to the one direction.

Subsequently, the coupled housings 10A, 10B and 10C are assembled with the frame 11. First, the coupled housings 10A, 10B and 10C are so oriented that the first cam pins 10F, 10G and 10H are arranged in rear end parts, and the frame 11 is so oriented that the finger placing portion 11R is arranged on the rear end.

Then, the coupled housings 10A, 10B and 10C are assembled with the frame 11 from the open right side of the frame 11. Specifically, the first cam pins 10F, 10G and are inserted in this order into the introducing grooves 11T.

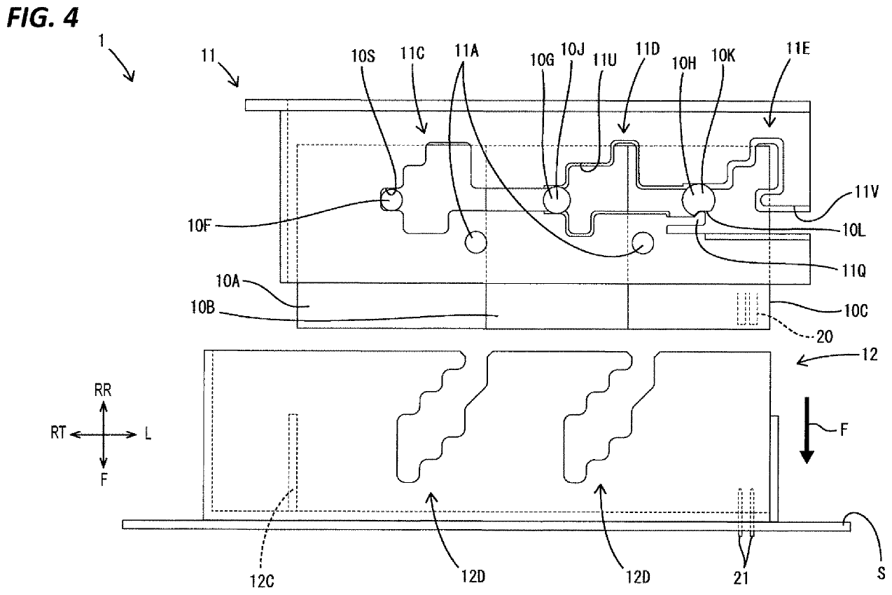

As shown in FIG. 4, the first cam pin 10F reaches the right end part of the guiding groove 11S, the first cam pin 10G reaches right end parts of the step portions 11U of the guiding groove 11S and the first cam pin 10H reaches right end parts of the step portions 11V of the guiding groove 11S. At this time, a rearward projecting part of the separation restricting portion 11Q is locked in the cut portion 10L of the different diameter portion 10K of the first cam pin 10H. In this way, the separation restricting portion 11Q restricts the separation of the first cam pin 10F from the right first guide groove 11C, the separation of the first cam pin 10G from the central first guide groove 11D and the separation of the first cam pin 10H from the left first guide groove 11E. That is, the separation restricting portion 11Q restricts the separation of the first cam pins 10F, 10G and 10H from the first guide groove 11B by locking the first cam pin In this way, the housings 10A, 10B and 10C are prevented from coming out from the frame 11.

At this time, the different diameter portion 10J of the first cam pin 10G is locked to the steps 11U of the guiding groove 11S, and the different diameter portion of the first cam pin 10H is locked to the step portions 11V of the guiding groove 11S. In this way, the expansion deformation of the respective upper and lower walls of the frame 11 is prevented. That is, the different diameter portions 10J, 10K function as escape preventing portions for preventing the first cam pins 10G, 10H from escaping from the first guide groove 11B. The first cam pins 10G, 10H include the escape preventing portions (different diameter portions 10J, 10K). Front end parts of the respective housings 10A, 10B and 10C project further forward than the front end of the frame 11.

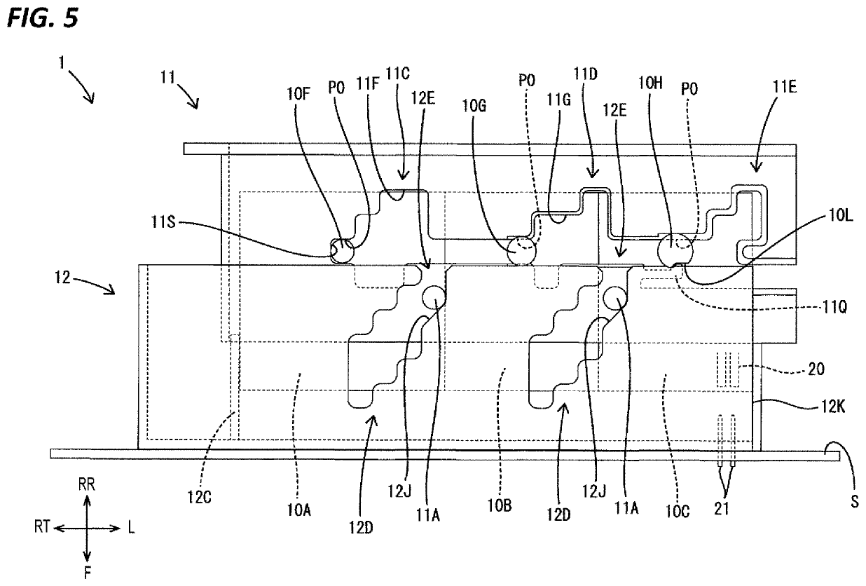

Subsequently, the frame 11 assembled with the housings 10A, 10B and 10C is fit into the mating housing 12. First, as shown in FIG. 4, a side of the frame 11 where the front end parts of the respective housings 10A, 10B and 10C project from the frame 11 is opposed to the mating housing 12. At this time, the open other end of the frame 11 is facing leftward. Then, the plurality of housings 10A, 10B and 10C are arranged side by side in a direction orthogonal to a connecting direction F of the plurality of housings 10B and 10C to the mating housing 12. Further, the plurality of housings 10A, and 10C are relatively movable in a direction parallel to the connecting direction F. Then, as shown in FIG. 5, the housings 10A, 10B and 10C and the frame 11 are inserted into the mating housing 12.

At this time, left end parts of the upper and lower walls of the frame 11 are inserted into the slits 12K while projecting to the left of the mating housing 12. Then, the right end of the housing 10A extends along the left surface of the restricting piece 12C, and the left end of the housing 10C extends along the inner surface (right surface) of the left wall of the mating housing 12. In this way, movements in the lateral direction of the housings 10A, 10B and 10C with respect to the mating housing 12 are restricted. Along with this, the inner surface (left surface) of the right wall of the frame 11 extends along the right surface of the restricting piece 12C. The first cam pins 10F, 10G and 10H are pressed forward by the rear end of the guiding groove 11S. In this way, the housings 10A, 10B and 10C move forward together with the frame 11. At this time, parts simultaneously pressing the first cam pins 10F, 10G and 10H at the rear end of the guiding groove 11S are initial pressing surfaces P0.

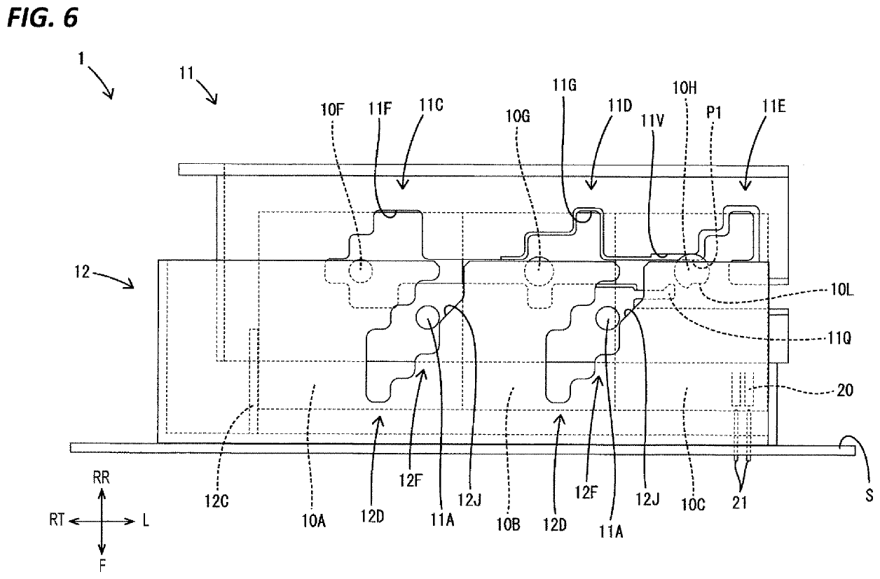

Each second cam pin 11A enters the entrance region 12E of each second guide groove 12D. Each second cam pin 11A reaches the inclined surface 12J and, further, the frame 11 enters the mating housing 12. Then, each second cam pin 11A moves along the inclined surface 12J and enters the left region 12F (see FIG. 6). In this way, the frame 11 moves rightward while moving forward.

Rightward movements of the housings 10A, 10B and 10C are restricted by the restricting piece 12C. Thus, the first cam pins 10F, 10G and 10H are relatively displaced leftward with respect to the frame 11 while being guided by the guiding groove 11S. Then, the first cam pins 10F, 10G are separated from the initial pressing surfaces P0 and reach positions in front of the first recesses 11F, 11G as shown in FIG. 6.

The separation restricting portion 11Q locked in the cut portion 10L of the different diameter portion 10K of the first cam pin 10H is disengaged from the cut portion 10L by being resiliently deformed forward. If the first cam pin 10H is relatively displaced further leftward, the separation restricting portion 11Q is separated from the different diameter portion 10K of the first cam pin 10H. The different diameter portion 10K of the first cam pin 10H is locked only to the step portion 11V at the rear end of the guiding groove 11S.

In this way, the second cam pins 11A are moved along the inclined surfaces 12J such that the separation restricting portion 11Q is separated from the first cam pin 10H while being resiliently deformed in the process of pressing the first cam pin 10H locked by the separation restricting portion 11Q by the initial pressing surface P0 formed in the first guide groove 11B. An operation of bringing the housing 10C having the first cam pins 10H locked to the separation restricting portions 11Q closer to the mating housing 12 and an operation of separating the first cam pins 10H from the separation restricting portions 11Q can be performed by one action by the inclined surfaces 12J.

Subsequently, the frame 11 is moved toward the mating housing 12 (forward). In a state of FIG. 6, the rear end (initial pressing surfaces P0) of the first guide groove 11B is not in contact with rear sides of the first cam pins 10F, 10G. Thus, even if the frame 11 is moved forward, the housings 10A, 10B do not move forward. If the frame 11 is moved forward, the first cam pins 10F, 10G are relatively displaced rearward with respect to the right first guide groove 11C and the central first guide groove 11D and enter the first recesses 11F, 11G.

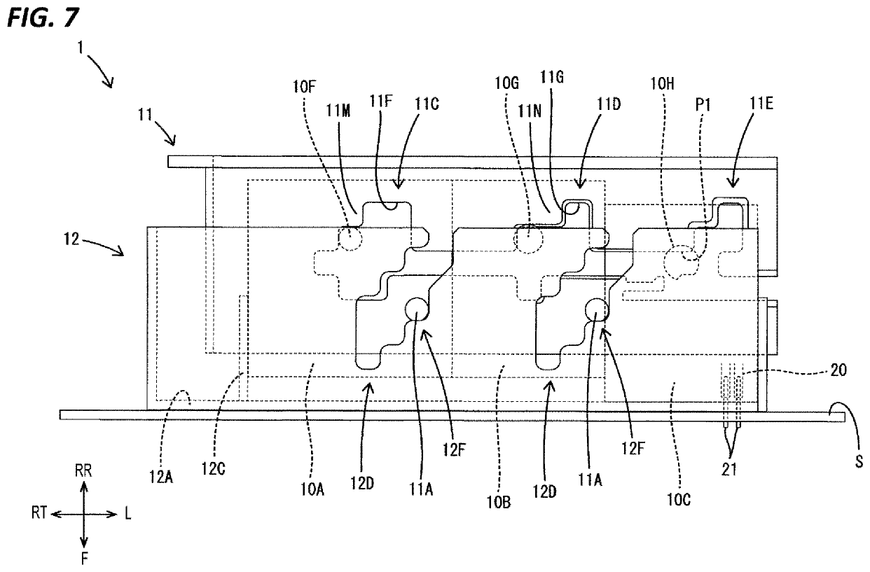

The first cam pin 10H is pressed forward by the rear end of the guiding groove 11S. In this way, the housing 10C moves forward together with the frame 11 and the male terminal fittings 21 are inserted into the female terminal fittings 20. At this time, a part pressing the first cam pin 10H forward at the rear end of the guiding groove 11S is a pressing surface P1. If the frame 11 and the housing 10C move further forward, the front end of the housing 10C contacts the base wall 12A of the mating housing 12 as shown in FIG. 7. The second cam pins 11A contact the front ends of the left regions 12F. The rear ends of the first cam pins 10F, 10G contact the front ends of the protrusions 11M, 11N. In this way, a connecting operation of the housing 10C, out of the three housings 10A, 10B and 10C, is finished.

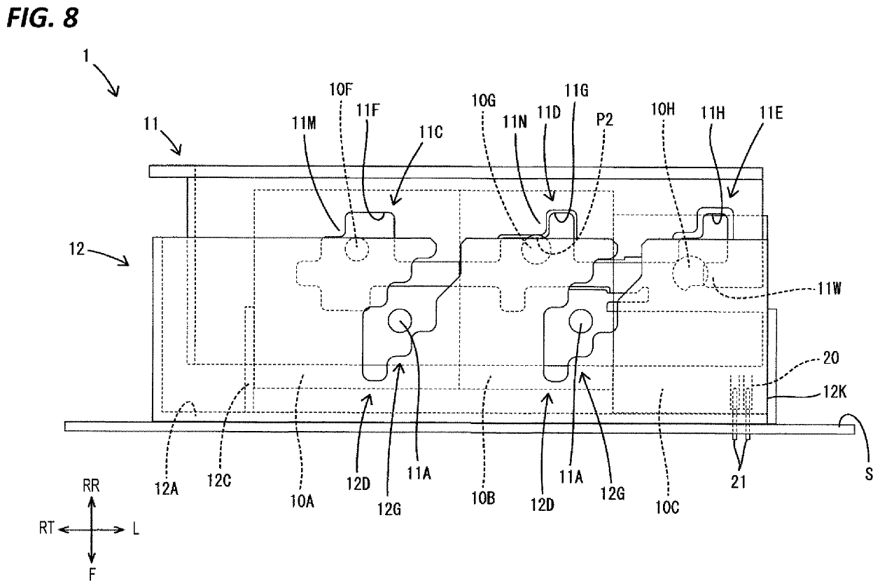

Subsequently, the frame 11 is moved rightward. Then, the first cam pin 10F is relatively displaced to the left of the protrusion 11M. The first cam pin 10G is relatively displaced leftward while being kept in contact with the front end of the protrusion 11N. The first cam pin 10H reaches a position in front of the first recess 11H as shown in FIG. 8. The first cam pin 10H is to the right of and adjacent to the second protrusion 11W. The second cam pins 11A are separated from the left regions 12F and enter the middle regions 12G. The left end parts of the upper and lower walls of the frame 11 projecting to the left of the mating housing 12 via the slits 12K are accommodated in the mating housing 12.

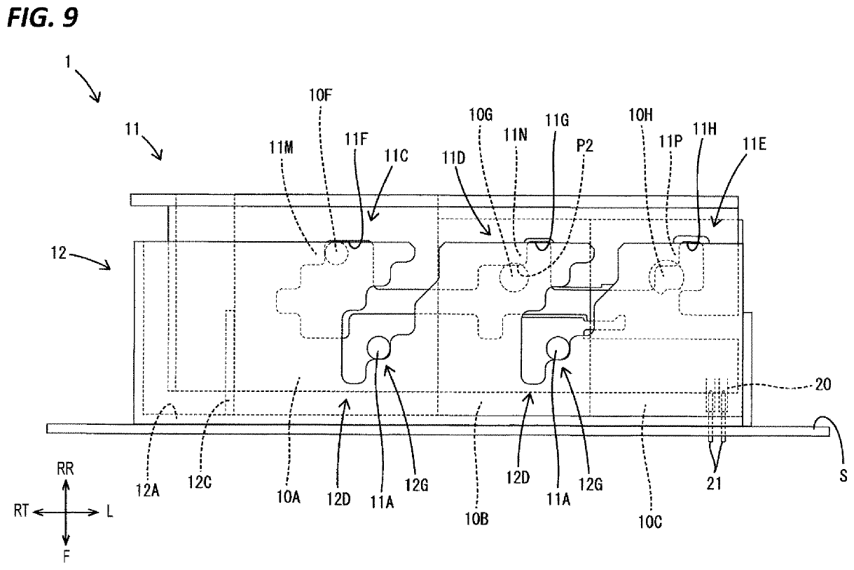

Subsequently, the frame 11 is moved forward. In a state of FIG. 8, the rear end of the first guide groove 11B is in contact with the rear sides of the first cam pins 10F, 10H. Thus, even if the frame 11 is moved forward, the housings 10A, 10C do not move forward. If the frame 11 is moved forward, the first cam pin 10F is relatively displaced rearward in the first recess 11F. Then, the first cam pin 10H is relatively displaced rearward and enters the first recess 11H (see FIG. 9).

The first cam pin 10G is pressed forward by the front end of the protrusion 11N. In this way, the housing 10B moves forward together with the frame 11 and the male terminal fittings 21 are inserted into the female terminal fittings 20. At this time, a part pressing the first cam pin 10G forward at the front end of the protrusion 11N is a pressing surface P2. If the frame 11 and the housing 10B move further forward, the front end of the housing 10B contacts the base wall 12A of the mating housing 12 as shown in FIG. 9. The second cam pins 11A contact the front ends of the middle regions 12G. The first cam pin 10F contacts the rear end of the first recess 11F and the first cam pin 10H contacts the front end of the protrusion 11P. In this way, a connecting operation of the housing 10B, out of the three housings 10A, 10B and 10C, is finished.

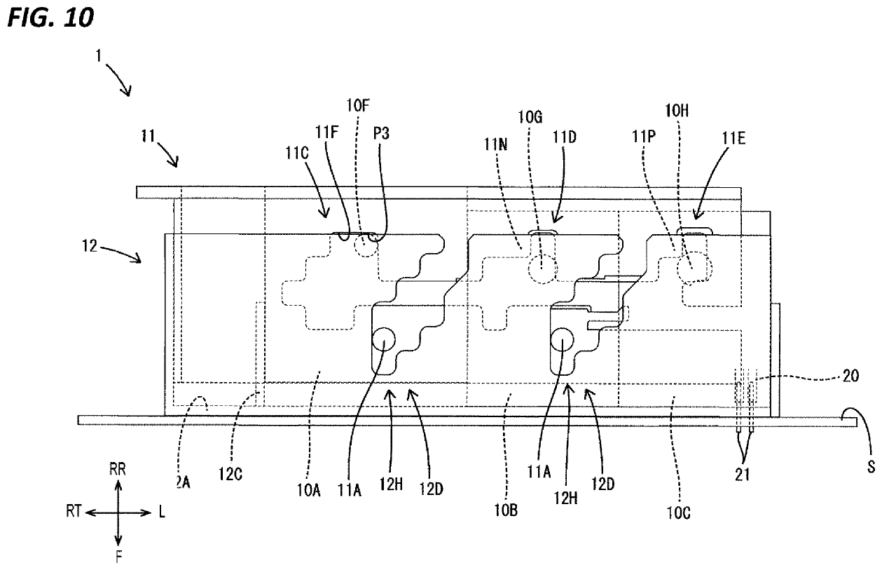

Subsequently, the frame 11 is moved rightward. Then, the first cam pin 10F is relatively displaced leftward in the first recess 11F. The first cam pin 10G is relatively displaced to the left of the protrusion 11N as shown in FIG. 10. The first cam pin 10H is relatively displaced to the left of the protrusion 11P. The second cam pins 11A are separated from the middle regions 12G and enter the right regions 12H.

Subsequently, the frame 11 is moved toward the mating housing 12. In a state of FIG. 10, the rear end of the first guide groove 11B is not in contact with the rear sides of the first cam pins 10G, 10H. Thus, even if the frame 11 is moved forward, the housings 10B, 10C do not move forward. If the frame 11 is moved forward, the first cam pins 10G, 10H are relatively displaced rearward in the first recesses 11G, 11H.

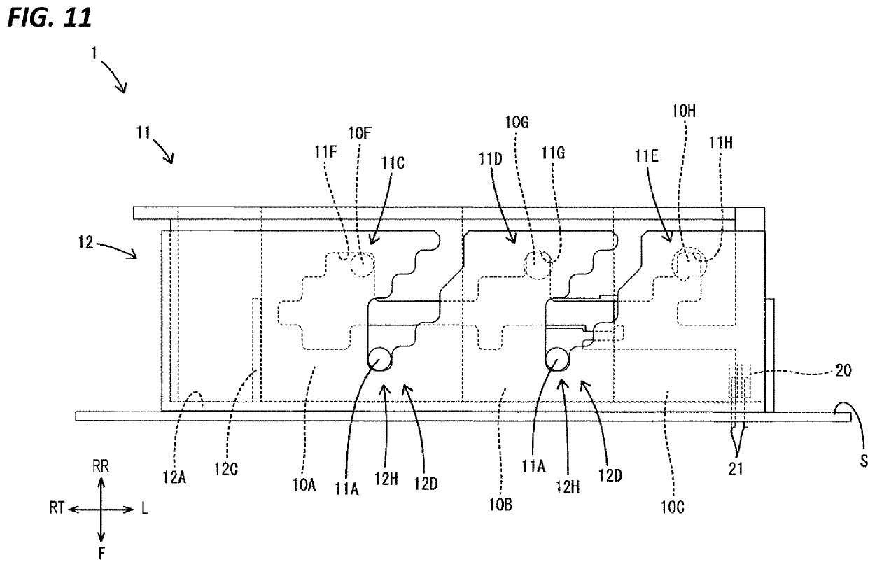

The first cam pin 10F is pressed forward by the rear end of the first recess 11F. In this way, the housing 10A moves forward together with the frame 11 and the male terminal fittings 21 are inserted into the female terminal fittings 20. At this time, a part pressing the first cam pin 10G forward at the rear end of the first recess 11F is a pressing surface P3. If the frame 11 and the housing 10A move further forward, the front end of the housing 10A contacts the base wall 12A of the mating housing 12 as shown in FIG. 11. Along with this, the front end of the frame 11 also contacts the base wall 12A of the mating housing 12. The second cam pins 11A contact the front ends of the right regions 12H. The first cam pins 10F, 10G and 10H contact the rear ends of the first recesses 11F, 11G and 11H. In this way, a connecting operation of the housing 10A, out of the three housings 10A, 10B and 10C, is finished.

At this time, the right wall of the frame 11 is adjacent to the inner surface (left surface) of the right wall of the mating housing 12. The frame 11 presses the plurality of housings 10A, 10B and 10C in a direction approaching the mating housing 12 respectively at different timings in the process of approaching the mating housing 12. The first guide groove 11B is formed with a plurality of the pressing surfaces P1, P2 and P3 for pressing the plurality of first cam pins 10F, 10G and 10H respectively at different timings.

### Separating Process of Connector

Next, a separating process of the connector 1 is described.

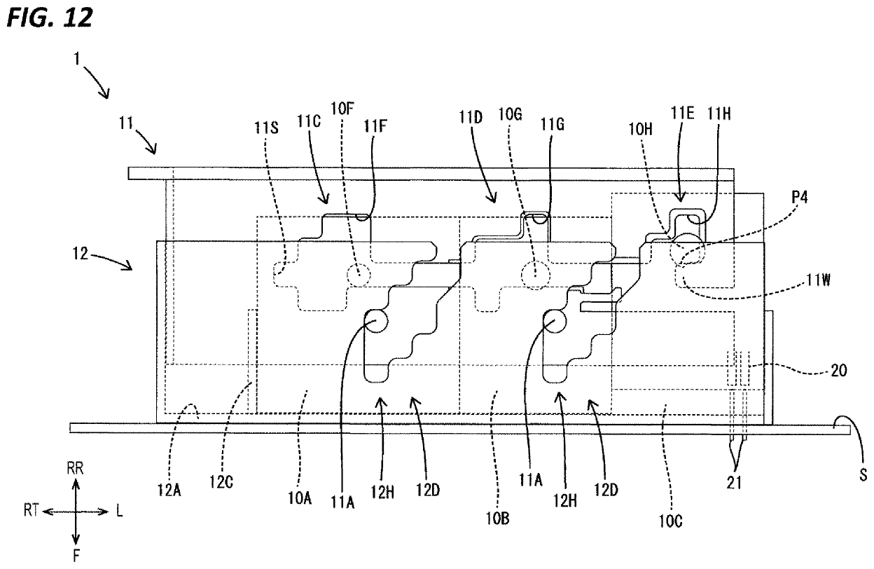

First, the frame 11 fit in the mating housing 12 is moved in a direction separating from the mating housing 12 (rearward). In a state of FIG. 11, the front end of the first guide groove 11B is not in contact with front sides of the first cam pins 10F, and 10H. Thus, even if the frame 11 is moved rearward, the housings 10A, 10B and 10C do not move rearward. The rear end of the second protrusion 11W contacts the first cam pin 10H from front while the frame 11 is moving rearward. Then, the first cam pin 10H is pressed rearward by the rear end of the second protrusion 11W. In this way, the housing 10C moves rearward together with the frame 11 and the male terminal fittings 21 are further separated from the female terminal fittings 20. At this time, a part pressing the first cam pin 10H rearward at the rear end of the second protrusion 11W is a separation pressing surface P4. If the frame 11 and the housing 10C move further rearward, the second cam pins 11A contact the rear ends of the right regions 12H as shown in FIG. 12. At this time, the front end of the guiding groove 11S contacts the front ends of the first cam pins 10F, 10G. In this way, a separating operation of the housing 10C, out of the three housings 10A, 10B and 10C, is finished.

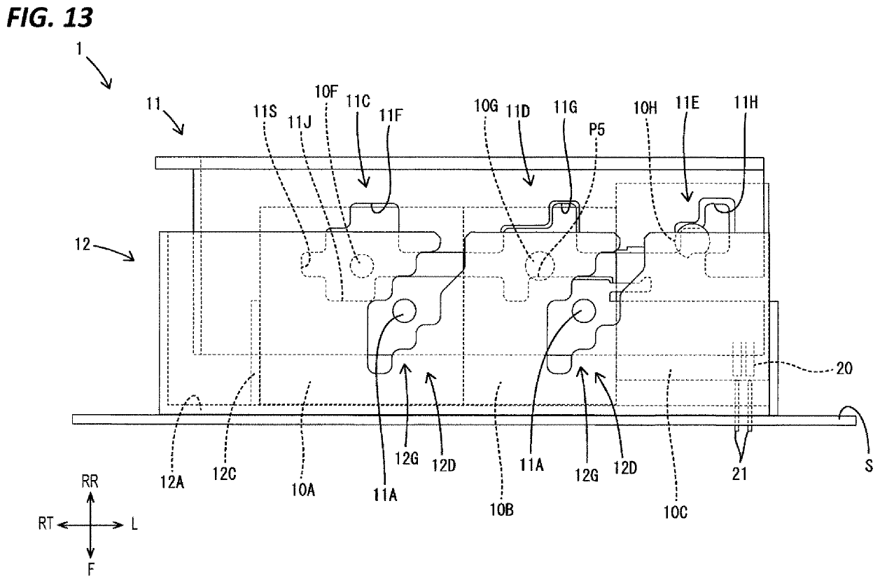

Subsequently, the frame 1 is moved leftward. Then, the first cam pins 10F, are relatively displaced rightward in the guiding groove 11S. The first cam pin is relatively displaced rightward in the first recess 11H. The second cam pins 11A are separated from the right regions 12H and enter the middle regions 12G as shown in FIG. 13.

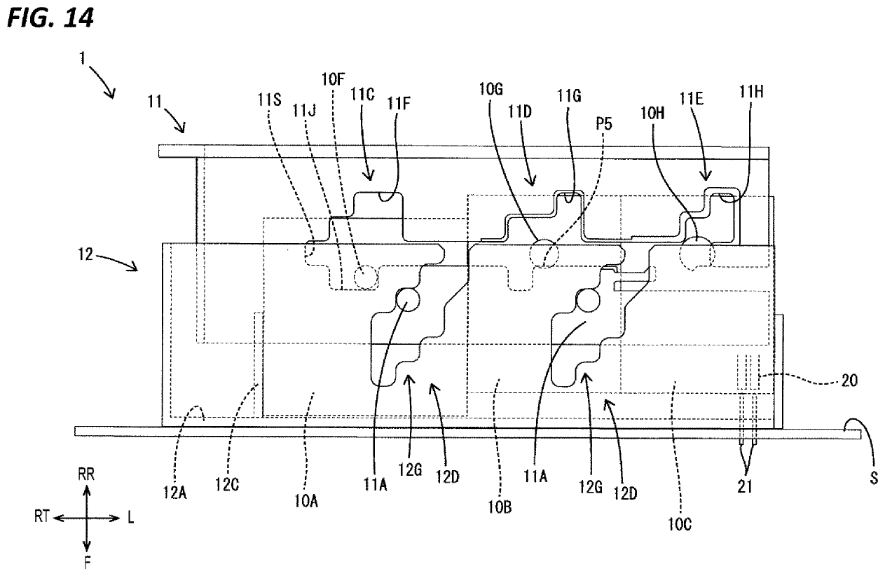

Subsequently, the frame 11 is moved rearward. In a state of FIG. 13, the front end of the first guide groove 11B is not in contact with the front sides of the first cam pins 10F, 10H. Thus, even if the frame 11 is moved rearward, the housings 10A, 10C do not move rearward. Accordingly, the first cam pin 10F is relatively displaced forward with respect to the right first guide groove 11C and enters the second recess 11J. The first cam pin 10H is relatively displaced forward with respect to the left first guide groove 11E and enters the guiding groove 11S. The first cam pin 10G is pressed rearward by the front end of the guiding groove 11S. In this way, the housing 10B moves rearward together with the frame 11 and the male terminal fittings 21 are separated from the female terminal fittings 20. At this time, a part pressing the first cam pin 10G rearward at the front end of the guiding groove 11S is a separation pressing surface P5 as shown in FIG. 14. If the frame 11 and the housing 10B move further rearward, the second cam pins 11A contact the rear ends of the middle regions 12G. Along with this, the first cam pin 10F contacts the front end of the second recess 11J. In this way, a separating operation of the housing 10B, out of the three housings 10A, 10B and 10C, is finished.

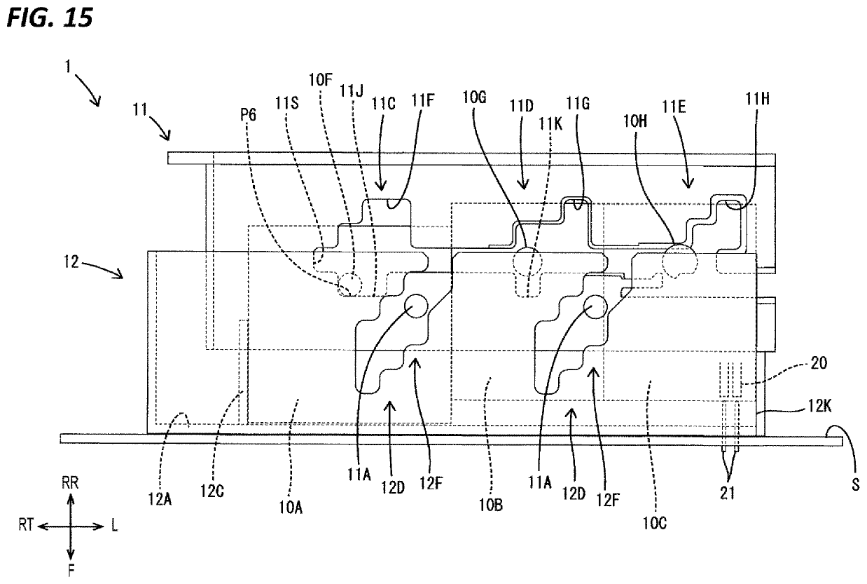

Subsequently, the frame 11 is moved leftward. Then, the first cam pin 10F is relatively displaced rightward in the second recess 11J. The first cam pins 10G, 10H are relatively displaced rightward in the guiding groove 11S. The first cam pin 10G reaches a position behind the second recess 11K as shown in FIG. 15. The second cam pins 11A are separated from the middle regions 12G and enter the left regions 12G. The left end parts of the upper and lower walls of the frame 11 pass leftward through the slits 12K and project further leftward than the left wall of the mating housing 12.

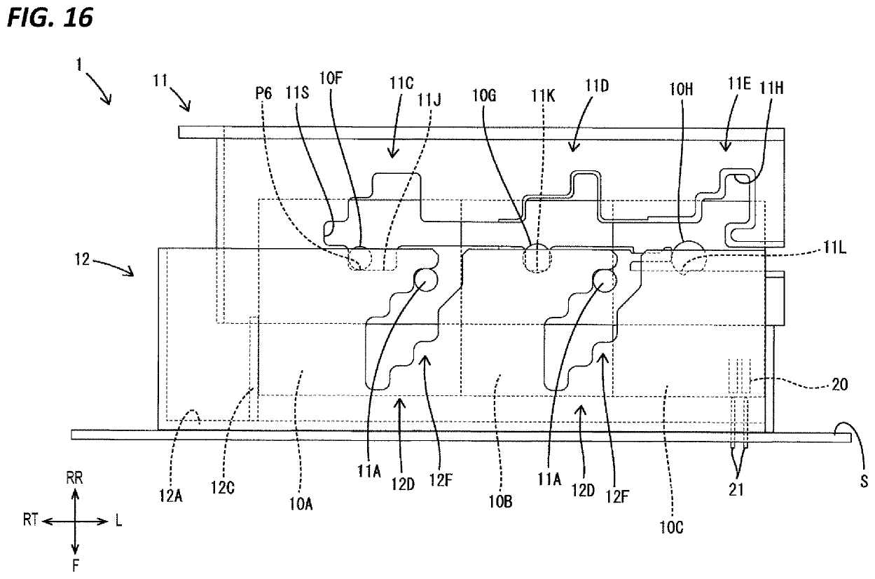

Subsequently, the frame 11 is moved rearward. In a state of FIG. 15, the front end of the first guide groove 11B is not in contact with the front sides of the first cam pins 10G, 10H. Thus, even if the frame 11 is moved rearward, the housings 10B, 10C do not move rearward. Accordingly, the first cam pin 10G is relatively displaced forward with respect to the central first guide groove 11D and enters the second recess 11K. The first cam pin 10H is relatively displaced forward with respect to the left first guide groove 11E and enters the second recess 11L. The first cam pin 10F is pressed rearward by the front end of the second recess 11J. In this way, the housing 10A moves rearward together with the frame 11 and the male terminal fittings 21 are separated from the female terminal fittings 20. At this time, a part pressing the first cam pin 10F rearward at the front end of the second recess 11J is a separation pressing surface P6. If the frame 11 and the housing 10A move further rearward, the second cam pins 11A contact the rear ends of the left regions 12F as shown in FIG. 16. At this time, the first cam pins 10G, 10H contact the front ends of the second recesses 11K, 11L. In this way, a separating operation of the housing 10A, out of the three housings 10A, 10B and 10C, is finished.

### Removal of Frame from Mating Housing

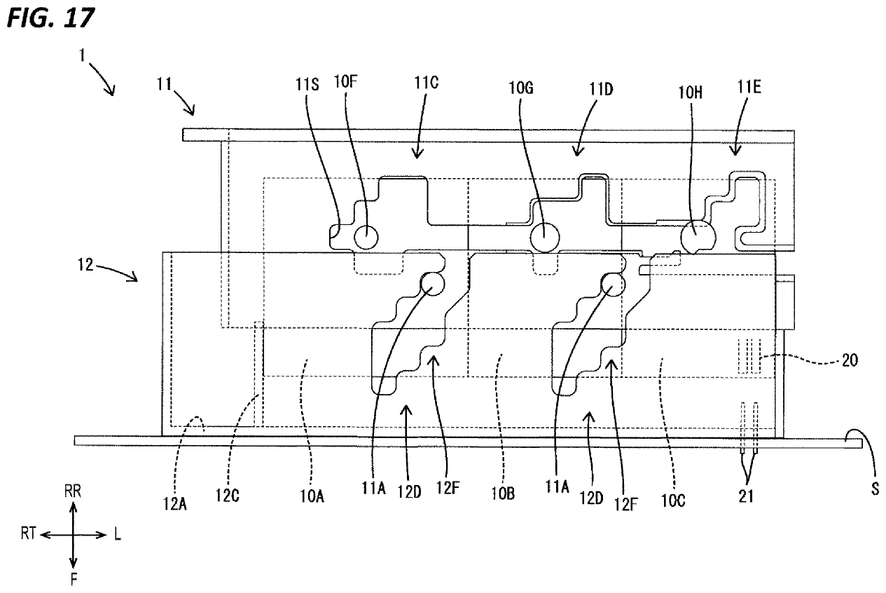

In a state where the separating operations of the housings 10A, 10B and 10C are finished in this way, the rear end of the first guide groove 11B is not in contact with the rear sides of the first cam pins 10F, 10G and 10H. Accordingly, the housings 10A, and 10C are moved rearward. In this case, for example, the wires W fixed to the female terminal fittings 20 are gripped and pulled rearward. Then, the respective first cam pins 10F, 10G and 10H enter the guiding groove 11S. At this time, the first cam pin 10H contacts the rear end of the guiding groove 11S as shown in FIG. 17.

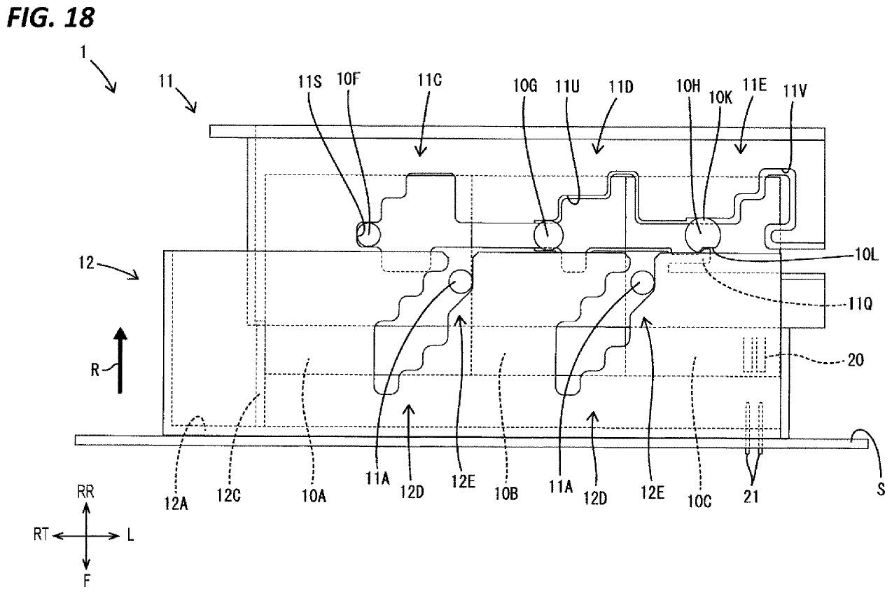

Subsequently, the frame 11 is moved leftward. Then, the first cam pins 10F, and 10H are relatively displaced rightward in the guiding groove 11S. The first cam pin 10F reaches the right end part of the guiding groove 11S as shown in FIG. 18. The first cam pin 10G reaches the right end parts of the step portions 11U of the guiding groove 11S. The first cam pin 10H reaches the right end parts of the step portions 11V of the guiding groove 11S, and the rearward projecting part of the separation restricting portion 11Q is locked in the cut portion 10L of the different diameter portion 10K of the first cam pin 10H. The second cam pins 11A are separated from the left regions 12F and enter the entrance regions 12E. In this way, the second cam pins 11A become separable from the entrance regions 12E to sides behind the entrance regions 12E. In this way, the frame 11 and the housings 10A, 10B and 10C can be removed from the mating housing 12.

At this time, the right wall of the frame 11 is adjacent to the right surface of the restricting piece 12C of the mating housing 12. The frame 11 presses the plurality of housings 10A, 10B and 10C in a separating direction R from the mating housing 12 respectively at different timings in the process of separating from the mating housing 12 in this way. The first guide groove 11B is formed with the separation pressing surfaces P4, P5 and P6 for pressing the plurality of first cam pins 10F, 10G and 10H in the separating direction R respectively at different timings.

Next, functions and effects of this embodiment are described.

The connector 1 of the present disclosure is provided with the plurality of housings 10A, 10B and 10C, the mating housing 12 and the frame 11. The plurality of housings 10A, 10B and 10C are connected to the mating housing 12. The frame 11 presses the plurality of housings 10A, 10B and 10C in the direction approaching the mating housing 12 respectively at different timings in the process of approaching the mating housing 12. According to this configuration, since the frame 11 presses the respective housings 10A, 10B and 10C at different timings, a connection operation force necessary to connect the housings 10A, 10B and 10C and the mating housing 12 is dispersed. Therefore, according to the present disclosure, the connection operation force can be reduced as compared to the case where all the housings 10A, 10B and 10C are simultaneously pressed.

The plurality of housings 10A, 10B and 10C of the connector 1 of the present disclosure include the first cam pins 10F, 10G and 10H. The frame 11 includes the first guide grooves 11B formed with the plurality of pressing surfaces P1, P2 and P3 for pressing the plurality of first cam pins 10F, 10G and 10H respectively at different timings and the second cam pins 11A. The mating housing 12 includes the receptacle 12B for accommodating the plurality of housings 10A, 10B and 10C. The receptacle 12B includes the plurality of second guide grooves 12D for individually guiding the plurality of second cam pins 11A. According to this configuration, since a movement path of the frame 11 with respect to the mating housing 12 is stabilized, the frame 11 can press the plurality of housings 10A, 10B and 10C at proper timings.

The plurality of first cam pins 10G, 10H of the connector 1 of the present disclosure include the different diameter portions 10J, 10K having mutually different outer diameters. The frame 11 includes the guiding grooves 11S for guiding the first cam pins 10F, 10G and 10H into the first guide grooves 11B. The guiding groove 11S includes the step portions 11U for restricting the passage of the different diameter portion 10K, out of the plurality of different diameter portions 10J, 10K. According to this configuration, in the process that the first cam pins 10F, 10G and 10H pass through the guiding grooves 11S as the housings 10A, 10B and 10C are mounted into the frame 11, the step portions 11U restrict the passage of the different diameter portions 10K. In this way, the plurality of housings 10A, 10B and 10C can be assembled in a proper order.

The first cam pins 10F, 10G and 10H of the connector 1 of the present disclosure include the different diameter portions 10J, 10K for preventing the first cam pins 10F, 10G and 10H from coming out from the first guide grooves 11B. According to this configuration, the housings 10A, 10B and 10C can be prevented from coming out from the frame 11.

The frame 11 of the connector 1 of the present disclosure includes the separation restricting portions 11Q for restricting the separation of the first cam pins 10F, 10G and 10H from the first guide grooves 11B by locking the first cam pins 10H. According to this configuration, the housings 10A, 10B and 10C and the frame 11 in a temporarily assembled state can be easily handled by restricting the separation of the housings 10A, 10B and 10C from the frame 11.

The separation restricting portion 11Q of the connector 1 of the present disclosure is separable from the first cam pin 10H by being resiliently deformed. The second guide grooves 12D have the inclined surfaces 12J. The first cam pin 10H locked by the separation restricting portion 11Q is pressed by the initial pressing surface P0 formed in the first guide groove 11B. In this process, the second cam pins 11A are moved along the inclined surfaces 12J such that the separation restricting portion 11Q is separated from the first cam pins 10F, 10G and 10H while being resiliently deformed. According to this configuration, if the second cam pins 11A move along the inclined surfaces 12J, the housing 10C having the first cam pins 10H locked by the separation restricting portions 11Q approaches the mating housing 12 and the first cam pins 10H are separated from the separation restricting portions 11Q. Workability is excellent as compared to the case where the operation of separating the first cam pins 10H from the separation restricting portions 11Q is performed separately from the connecting operation of the housing 10C and the mating housing 12.

The plurality of housings 10A, 10B and 10C of the connector 1 of the present disclosure are coupled relatively movably in the direction parallel to the connecting direction F of the plurality of housings 10A, 10B and 10C to the mating housing 12 while being arranged side by side in the direction orthogonal to the connecting direction F. According to this configuration, since the plurality of housings 10A, 10B and 10C do not come apart from each other, the plurality of housings 10A, 10B and 10C can be assembled with the frame 11 by one action.

### Other Embodiments

The present disclosure is not limited to the above described and illustrated embodiment, but is represented by claims. The present disclosure is intended to include all changes in the scope of claims and in the meaning and scope of equivalents and also include the following embodiments.
(1) The embodiment discloses that the mating housing is mounted on the circuit board. Without limitation to this, male terminal fittings connected to wires may be fixed in the mating housing.
(2) The embodiment discloses three housings. However, the number of the housings is not limited to this.
(3) The embodiment discloses that the right housing includes more terminal accommodation chambers. However, the numbers of the terminal accommodation chambers in the housings may be equal.
(4) The embodiment discloses that the terminal accommodation chambers are in the same form. However, the forms of the terminal accommodation chambers conform to the forms of the terminal fittings used. Thus, the terminal accommodation chambers may not be in the same form.
(5) The embodiment discloses that the first and second guide grooves are formed in each of the upper and lower walls. However, the first and second guide grooves may be formed only in either one of the upper and lower walls.

### LIST OF REFERENCE NUMERALS

1 . . . connector
10A, 10B, 10C . . . housing
10D. . . engaging portion
10E . . . engaged portion
10F, 10G, 10H . . . first cam pin
10J, 10K . . . different diameter portion (escape preventing portion) cut portion
10L . . . terminal accommodation chamber
11 . . . frame (pressing member)
11A . . . second cam pin
11B . . . first guide groove
11C . . . right first guide groove (first guide groove)
11D . . . central first guide groove (first guide groove)
11E . . . left first guide groove (first guide groove)
11F, 11G, 11H . . . first recess
11J, 11K, 11L . . . second recess
11M, 11N, 11P . . . protrusion
11Q . . . separation restricting portion
11R . . . finger placing portion
11S . . . guiding groove
11T . . . introducing groove
11U . . . step portion (restricting portion)
11V . . . step portion
11W . . . second protrusion
12 . . . mating housing
12A . . . base wall
12B . . . receptacle
12C . . . restricting piece
12D . . . second guide groove
12E . . . entrance region
12F . . . left region
12G . . . middle region
12H . . . right region
12J . . . inclined surface
12K . . . slit
20 . . . female terminal fitting
21 . . . male terminal fitting
F connecting direction
P0 . . . initial pressing surface
P1, P2, P3 . . . pressing surface
P4, P5, P6 . . . separation pressing surface
S . . . circuit board
R . . . separating direction
W . . . wire

Listings of claims:

1. A connector, comprising:
a plurality of housings;
a mating housing to be connected to the plurality of housings; and
a pressing member for pressing the plurality of housings in a direction approaching the mating housing respectively at different timings in the process of approaching the mating housing.

2. The connector of claim 1, wherein:
each of the plurality of housings includes a first cam pin,
the pressing member includes a first guide groove formed with a plurality of pressing surfaces for pressing a plurality of the first cam pins respectively at the different timings, and second cam pins,
the mating housing includes a receptacle for accommodating the plurality of housings, and
the receptacle includes a plurality of second guide grooves for individually guiding a plurality of the second cam pins.

3. The connector of claim 2, wherein:
the plurality of first cam pins include different diameter portions having mutually different outer diameters,
the pressing member includes a guiding groove for guiding the first cam pins into the first guide groove, and
the guiding groove includes a restricting portion for restricting passage of some different diameter portions, out of the plurality of different diameter portions.

4. The connector of claim 2, wherein the first cam pin includes an escape preventing portion for preventing the first cam pin from coming out from the first guide groove.

5. The connector of claim 2, wherein the pressing member includes a separation restricting portion for restricting separation of the first cam pins from the first guide groove by locking the first cam pin.

6. The connector of claim 5, wherein:
the separation restricting portion is separable from the first cam pin by being resiliently deformed, and
the plurality of second guide grooves have inclined surfaces for moving the second cam pins such that the separation restricting portion is separated from the first cam pin while being resiliently deformed in the process of pressing the first cam pin locked by the separation restricting portion by an initial pressing surface formed in the first guide groove.

7. The connector of claim 1, wherein the plurality of housings are coupled relatively movably in a direction parallel to a connecting direction of the plurality of housings to the mating housing while being arranged side by side in a direction orthogonal to the connecting direction.
